(19) United States
(12) Patent Application Publication
(10) Pub. No.: US 2024/0178623 A1
(43) Pub. Date: May 30, 2024

(54) Power Outlet Extender Device

(71) Applicant: Kristopher Bennett, Williamson, GA (US)

(72) Inventor: Kristopher Bennett, Williamson, GA (US)

(21) Appl. No.: 18/513,875

(22) Filed: Nov. 20, 2023

Related U.S. Application Data
(60) Provisional application No. 63/428,441, filed on Nov. 29, 2022.

(51) Int. Cl. H01R 13/73; H01R 27/02

(52) U.S. Cl. CPC H01R 13/73; H01R 27/02

(57) ABSTRACT

A power outlet extender device is provided. The device is comprised of a housing having at least one power outlet with at least one receptacle and at least one fastener. The outlet receives power from at least one power cord that can be plugged into an existing power outlet. The housing can then be attached to any surface, object, etc. via at least one fastener of the housing. The outlet is further surrounded by a decorative face plate.

### CROSS-REFERENCE TO RELATED APPLICATION

The present application claims priority to, and the benefit of, U.S. Provisional Application No. 63/428,441, which was filed on Nov. 29, 2022, and is incorporated herein by reference in its entirety.

### FIELD OF THE INVENTION

The present invention relates generally to the field of power outlets. More specifically, the present invention relates to a power outlet extender device comprised of a repositionable power outlet with a decorative faceplate. Accordingly, the present disclosure makes specific reference thereto. Nonetheless, it is to be appreciated that aspects of the present invention are also equally applicable to other like applications, devices, and methods of manufacture.

### BACKGROUND

Accessing electrical outlets that are positioned behind heavy furniture or in other hard-to-reach areas often leads to a common annoyance and frustration for many. This inconvenience is exacerbated when people find themselves compelled to rely on the use of bulky and unsightly extension cords, which often lie disorganized on the floor. This not only contributes to visual clutter but also poses a significant safety risk as a potential tripping hazard.

Furthermore, the task of shifting furniture to gain access to an outlet can be a particularly daunting challenge, which becomes even more problematic for those with physical limitations. The physical exertion and the time spent in trying to simply plug in a device highlight the inefficiency of current electrical outlet placement in relation to the modern-day layout of living spaces.

Therefore, there exists a long-felt need in the art for an improved power receptacle. There also exists a long-felt need in the art for a power outlet extender device. More specifically, there exists a long-felt need in the art for a power outlet extender device that provides a repositionable power outlet.

The subject matter disclosed and claimed herein, in one embodiment thereof, comprises a power outlet extender device. The device is comprised of a housing having at least one power outlet with at least one receptacle and at least one fastener. The outlet receives power from at least one power cord that can be plugged into an existing power outlet. The housing can then be attached to any surface, object, etc. via at least one fastener of the housing. The outlet is further surrounded by a decorative face plate.

In this manner, the power outlet extender device of the present invention accomplishes all the forgoing objectives and provides an improved power receptacle. More specifically, the device provides a repositionable power outlet. In this manner, the device eliminates the need for extension cords and allows a user to choose the specific position of additional power outlets.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a power outlet extender device. The device is primarily comprised of at least one housing with at least one power outlet, wherein the housing can be secured to a wall or other surface and/or object via at least one fastener. The device is comprised of at least one power cord that allows the device to be plugged into an existing power source such that the device provides the appearance and functionality of a traditional wall outlet while offering a user the ability to reposition the device as needed.

The power outlet of the housing may be surrounded in one embodiment with at least one decorative face plate. The face plate may be secured to the housing via at least one fastener such as but not limited to a screw, a magnet, etc. The face plate may be made from any material and may have any appearance, finish, pattern, design, etc. known in the art.

The power outlet is comprised of at least one primary receptacle. The receptacle is preferably a female power outlet, although the receptacle may be any power outlet type known in the art. In one embodiment, the outlet may be additionally or alternatively comprised of at least one secondary receptacle. The secondary receptacle is preferably but not limited to any type of USB port known in the art. This includes but is not limited to USB C, USB A, Micro-USB, etc. The outlet receives power from at least one power cord.

To allow the housing to be positioned in various locations and attached to various surfaces, objects, etc. the housing may be comprised of at least one fastener. The fastener may be but is not limited to removable/non-removable adhesive, magnet, hook and loop, elastic, etc. The fastener preferably does not damage paint when applied to a painted surface.

The present invention is also comprised of a method of using the device. First, a device is provided comprised of a housing comprised of a fastener, a power cord, and a power outlet comprised of at least one receptacle. Then, the housing can be attached to a surface, item, etc. via the fastener. Then, the power cord can be plugged into a power source such as but not limited to a female outlet. Next, an electronic device can be plugged into a receptacle of the outlet to receive power.

The present invention is also comprised of a second method of using the device. First, a device is provided comprised of a housing comprised of a fastener and a face plate, a power cord, and a power outlet comprised of at least one receptacle. Then, the face plate can be attached to the housing around the power outlet via at least one fastener. Then, the housing can be attached to a surface, item, etc. via the fastener. Then, the power cord can be plugged into a power source such as but not limited to a female outlet. Next, an electronic device can be plugged into a receptacle of the outlet to receive power.

Accordingly, the power outlet extender device of the present invention is particularly advantageous as it provides an improved power receptacle. More specifically, the device provides a repositionable power outlet. In this manner, the device eliminates the need for extension cords and allows a user to choose the specific position of additional power outlets. In this manner, the power outlet extender device overcomes the limitations of existing power outlets known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a power outlet extender device of the present invention while attached to a surface in accordance with the disclosed architecture;

FIG. 2 illustrates a front view of one potential embodiment of a power outlet extender device of the present invention in accordance with the disclosed architecture;

FIG. 3 illustrates a flowchart of a method of using one potential embodiment of a power outlet extender device of the present invention in accordance with the disclosed architecture; and

FIG. 4 illustrates a flowchart of a method of using one potential embodiment of a power outlet extender device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved power receptacle. There also exists a long-felt need in the art for a power outlet extender device. More specifically, there exists a long-felt need in the art for a power outlet extender device that provides a repositionable power outlet.

The present invention, in one exemplary embodiment, is comprised of a power outlet extender device primarily comprised of at least one housing with at least one power outlet, wherein the housing can be secured to a wall or other surface and/or object via at least one fastener. The device is comprised of at least one power cord that allows the device to be plugged into an existing power source such that the device provides the appearance and functionality of a traditional wall outlet while offering a user the ability to reposition the device as needed.

The power outlet of the housing may be surrounded in one embodiment with at least one decorative face plate. The face plate may be secured to the housing via at least one fastener such as but not limited to a screw, a magnet, etc. The face plate may be made from any material and may have any appearance, finish, pattern, design, etc. known in the art.

The power outlet is comprised of at least one primary receptacle which is preferably a female power outlet. In one embodiment, the outlet may be additionally or alternatively comprised of at least one secondary receptacle. The secondary receptacle is preferably but not limited to any type of USB port known in the art. This includes but is not limited to USB C, USB A, Micro-USB, etc. The outlet receives power from at least one power cord.

To allow the housing to be positioned in various locations and attached to various surfaces, objects, etc. the housing may be comprised of at least one fastener. The fastener may be but is not limited to removable/non-removable adhesive, magnet, hook and loop, elastic, etc. The fastener preferably does not damage paint when applied to a painted surface.

The present invention is also comprised of a method of using the device. First, a device is provided comprised of a housing comprised of a fastener, a power cord, and a power outlet comprised of at least one receptacle. Then, the housing can be attached to a surface, item, etc. via the fastener. Then, the power cord can be plugged into a power source such as but not limited to a female outlet. Next, an electronic device can be plugged into a receptacle of the outlet to receive power.

The present invention is also comprised of a second method of using the device. First, a device is provided comprised of a housing comprised of a fastener and a face plate, a power cord, and a power outlet comprised of at least one receptacle. Then, the face plate can be attached to the housing around the power outlet via at least one fastener. Then, the housing can be attached to a surface, item, etc. via the fastener. Then, the power cord can be plugged into a power source such as but not limited to a female outlet. Next, an electronic device can be plugged into a receptacle of the outlet to receive power.

Accordingly, the power outlet extender device of the present invention is particularly advantageous as it provides an improved power receptacle. More specifically, the device provides a repositionable power outlet. In this manner, the device eliminates the need for extension cords and allows a user to choose the specific position of additional power outlets. In this manner, the power outlet extender device overcomes the limitations of existing power outlets known in the art.

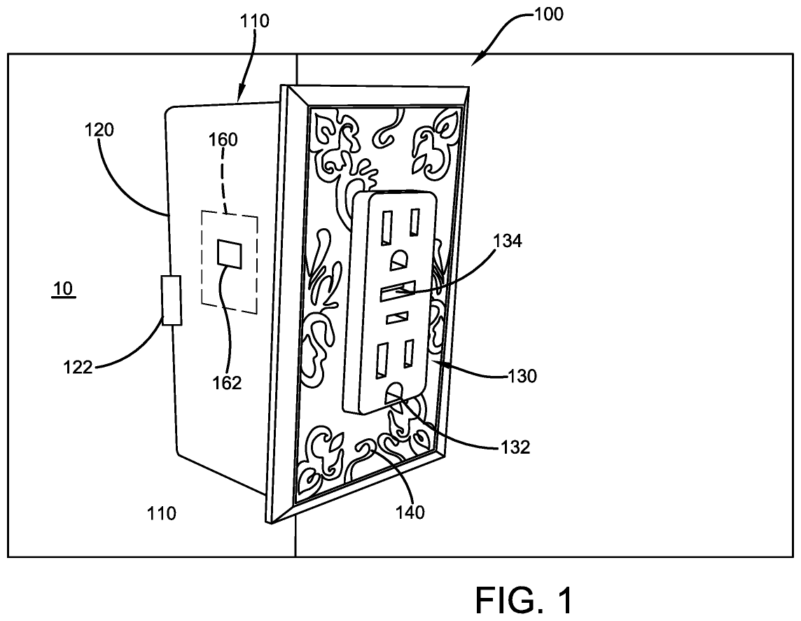

Referring initially to the drawings, FIG. 1 illustrates a perspective view of one potential embodiment of a power outlet extender device 100 of the present invention while attached to a surface 10 in accordance with the disclosed architecture. The device 100 is primarily comprised of at least one housing 110 with at least one power outlet 130. The housing 110 can be secured to a wall or other surface 10 and/or object via at least one fastener 122. The device 100 is comprised of at least one power cord 150 that allows the device 100 to be plugged into an existing power source. In this manner, the device 100 provides the appearance and functionality of a traditional wall outlet while offering a user the ability to reposition the device 100 as needed.

The housing 110 of the device 100 is preferably comprised of a plastic material. However, the housing 110 may be made of any material and may have the appearance of any material, finish, etc. known in the art. This allows the housing 110 to fit into the surrounding décor of the area the device 100 is used in. The housing 110 is preferably (but not limited to) rectangular with a rear wall 120 and four side walls 110.

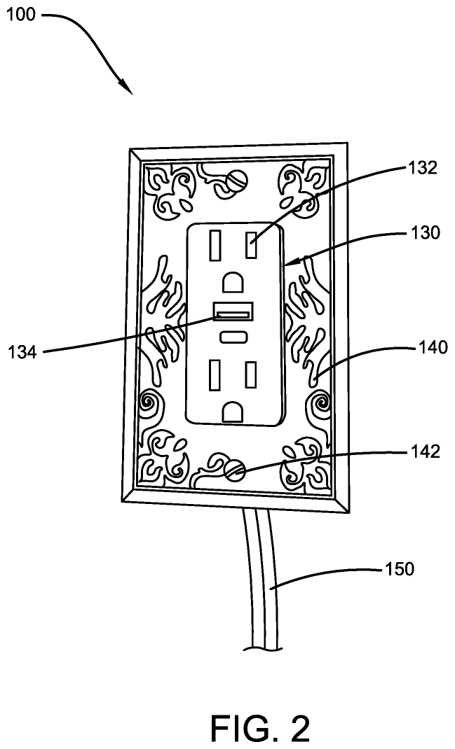

The housing 110 is further comprised of at least one power outlet 130. The power outlet 130 may be surrounded in one embodiment with at least one decorative face plate 140, as seen in FIG. 2. The face plate 140 may be secured to the housing 110 via at least one fastener 142 such as but not limited to a screw, a magnet, etc. The face plate 140 may be made from any material and may have any appearance, finish, pattern, design, etc. known in the art.

The power outlet 130 is comprised of at least one primary receptacle 132. The receptacle is preferably a 110 v/ 240 v female power outlet, although the receptacle 132 may be any power outlet type known in the art. In one embodiment, the outlet 130 may be additionally or alternatively comprised of at least one secondary receptacle 134. The secondary receptacle 134 is preferably but not limited to any type of USB port known in the art. This includes but is not limited to USB C, USB A, Micro-USB, etc.

The outlet 130 receives power from at least one power cord 150. The power cord 150 is preferably a male 110 v/240 v male receptacle, but may be any type known in the art. In one embodiment, the power outlet 130 is powered by at least one battery 160 stored within the housing 110. The battery 160 may be a removable or non-removable battery in different embodiments. In one embodiment, the battery 160 is disposable. In another embodiment, the battery 160 is rechargeable. In this embodiment, the battery 160 may be recharged via at least one charging port 162 such as but not limited to a USB port.

To allow the housing 110 to be positioned in various locations and attached to various surfaces 10, objects, etc. the housing 110 may be comprised of at least one fastener 122. More specifically, the rear wall 120 of the housing 110 is comprised of at least one fastener 122. The fastener 110 may be but is not limited to removable/non-removable adhesive, magnet, hook and loop, elastic, etc. The fastener 122 preferably does not damage paint (such as but not limited to wall paint) when applied to a painted surface.

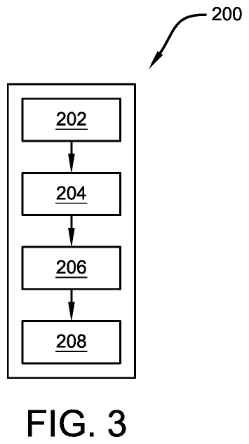

The present invention is also comprised of a method of using 200 the device 100, as seen in FIG. 3. First, a device 100 is provided comprised of a housing 110 comprised of a fastener 142, a power cord 150, and a power outlet 130 comprised of at least one receptacle 132,134 [Step 202]. Then, the housing 110 can be attached to a surface, item, etc. via the fastener 142 [Step 204]. Then, the power cord 150 can be plugged into a power source such as but not limited to a female 120 v/240 v outlet [Step 206]. Next, an electronic device can be plugged into a receptacle 132,134 of the outlet 130 to receive power [Step 208].

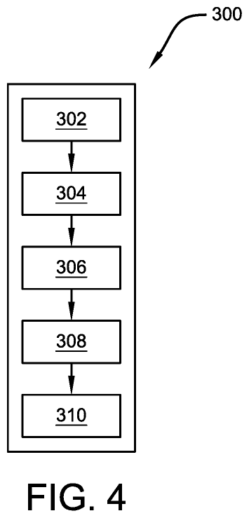

The present invention is also comprised of a second method of using 300 the device 100, as seen in FIG. 4. First, a device 100 is provided comprised of a housing 110 comprised of a fastener 142 and a face plate 140, a power cord 150, and a power outlet 130 comprised of at least one receptacle 132,134 [Step 302]. Then, the face plate 140 can be attached to the housing 110 around the power outlet 130 via at least one fastener 142 [Step 304]. Then, the housing 110 can be attached to a surface, item, etc. via the fastener 142 [Step 306]. Then, the power cord 150 can be plugged into a power source such as but not limited to a female 120 v/240 v outlet [Step 308]. Next, an electronic device can be plugged into a receptacle 132,134 of the outlet 130 to receive power [Step 310].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “power outlet extender device” and “device” are interchangeable and refer to the power outlet extender device 100 of the present invention.

Notwithstanding the forgoing, the power outlet extender device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the power outlet extender device 100 as shown in the FIGS. are for illustrative purposes only, and that many other sizes and shapes of the power outlet extender device 100 are well within the scope of the present disclosure. Although the dimensions of the power outlet extender device 100 are important design parameters for user convenience, the power outlet extender device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A power outlet extender device comprising:
a housing comprised of a power outlet, the power outlet comprised of a receptacle;
a first fastener; and
a power cord.

2. The power outlet extender device of claim 1, wherein the receptacle is comprised of a 120 v/240 v female outlet.

3. The power outlet extender device of claim 1, wherein the receptacle is comprised of a USB port.

4. The power outlet extender device of claim 1, wherein the power outlet is surrounded by a face plate.

5. The power outlet extender device of claim 4, wherein the face plate attaches to the housing via a second fastener.

6. The power outlet extender device of claim 1, wherein the power cord is comprised of a 120 v/240 v male power cord.

7. The power outlet extender device of claim 1, wherein the first fastener is comprised of an adhesive fastener.

8. A power outlet extender device comprising:
a housing comprised of a power outlet, the power outlet comprised of a first receptacle and a second receptacle;
a first fastener positioned on the housing; and
a power cord.

9. The power outlet extender device of claim 8, wherein the first receptacle is comprised of a 120 v/240 v female outlet.

10. The power outlet extender device of claim 8, wherein the second receptacle is comprised of a USB port.

11. The power outlet extender device of claim 8, wherein the power outlet is surrounded by a face plate.

12. The power outlet extender device of claim 11, wherein the face plate attaches to the housing via a second fastener.

13. The power outlet extender device of claim 12, wherein the second fastener is comprised of a screw.

14. The power outlet extender device of claim 8, wherein the power cord is comprised of a 120 v/240 v male power cord.

15. The power outlet extender device of claim 8, wherein the first fastener is comprised of an adhesive fastener.

16. A method of using a power outlet extender device, the method comprising the following steps:
providing a power outlet extender device comprised of a housing comprised of a first fastener, a power cord, and a power outlet comprised of a receptacle;
attaching the housing to a surface via the fastener;
plugging the power cord into a power source; and
plugging an electronic device into the receptacle.

17. The method of using a power outlet extender device of claim 16, wherein the receptacle is comprised of a USB receptacle or a 120 v/240 v receptacle.

18. The method of using a power outlet extender device of claim 16, wherein the first fastener is comprised of an adhesive fastener.

19. The method of using a power outlet extender device of claim 16, wherein the housing is comprised of a face plate that surrounds the receptacle.

20. The method of using a power outlet extender device of claim 19, wherein the face plate attaches to the housing via a second fastener.
